(19) United States
(12) Patent Application Publication
(10) Pub. No.: US 2008/0118612 A1
(43) Pub. Date: May 22, 2008

(54) Medicament Delivery System

(76) Inventor: Robert John Curtis, Newport (GB)

Correspondence Address: Tod T. Tumey, P.O. BOX 22188, HOUSTON, TX, 77227-2188, US

(21) Appl. No.: 11/577,586

(22) PCT Filed: Jun. 15, 2005
(86) PCT No.: PCT/GB05/02372

§ 371 Date: Oct. 29, 2007

(30) Foreign Application Priority Data
Oct. 25, 2004 (GB) 0423706.1

(51) Int. Cl. A61J 1/00

(52) U.S. Cl. 426/112

(57) ABSTRACT

A system for aiding delivery of a medicament, which system includes: a receptacle which includes an edible body; and a first removable cover member arranged to substantially seal they body in the receptacle, the first removable cover member having a protrusion thereon arranged to project away from the removable cover member into the edible body when the system is in use.

The present invention is concerned with a medicament delivery system.

It is known that many people (in particular small children or the elderly) and animals experience difficulty in swallowing medication in the form of tablets and capsules. In an attempt to disguise the medicament, the medicament has previously been combined with or disguised in some food. Whilst this may prevent the medicament being seen, it is often still rejected by the animal to which it was intended. In addition, this method of mixing a medicament with a foodstuff is messy for the person carrying out the mixing.

It is therefore an aim of the present invention to alleviate at least some of the disadvantages identified above.

It is a further aspect of the present invention to provide a medicament delivery system which is easy to use.

Therefore, according to a first aspect of the present invention, there is provided a system for aiding delivery of a medicament, which system includes:
a receptacle which includes an edible body; and
a first removable cover member arranged to substantially seal the body in the receptacle, the first removable cover member having a protrusion thereon arranged to project away from the removable cover member into the edible body when the system is in use.

Advantageously, the protrusion causes an indentation in the edible body which substantially remains when the removable cover member (including the protrusion) is removed from the receptacle. The indentation is suitable for inserting therein a medicament or the like.

The protrusion can be of any shape that creates an indentation in the edible foodstuff. The protrusion has a cross-section which is semi-circular, triangular or that of a trapezium. Alternatively, the protrusion is hemispherical.

It is further envisaged that the protrusion includes location means at the end distal the first cover member. The location means is arranged to assist positioning of a medicament in the edible body. The location means typically includes a recess or cavity, the recess or cavity arranged to receive a medicament. The location means is preferably arranged to hold the medicament until it is correctly positioned in the edible body.

Advantageously, in use, once the first removable cover means is removed from the receptacle, the protrusion leaves an indentation in the edible body. A medicament can be inserted into the indentation and the first removable cover member can be placed back in its original position such that the locating means forces the medicament into the desired place.

Typically, the receptacle is a tub or the like.

The edible body is preferably a foodstuff and may have a solid or semi-solid consistency. However, a moist foodstuff having a semi-solid consistency is particularly preferred. It is also envisaged that the edible body may include one or more vitamins, minerals, supplements or the like.

It is particularly preferred that the medicament is an edible medicament. The medicament may be in the form of a tablet, pellet, capsule, be granular or the like. It is envisaged that for domestic or agricultural animal use, the medicament may be a medicament suitable for the treatment of worms, fleas or the like, for prescribed medication or for vitamin supplement. However, if the medicament is for human use, it is envisaged that the medicament may be for relief of headaches, nausea and may include aspirin, paracetamol or other non-prescribed medication. The present invention is, of course, not limited to any specific medication.

The present invention may be utilised to assist animals (including humans) to swallow a medicament. Animals may include domestic animals, such as cats and dogs, however it is envisaged that the present invention may extend to agricultural animals.

Providing a medicament within an edible body will serve to mask the appearance, odour, flavour, colour and also texture of the medicament. The consistency of the edible body may therefore be chosen to provide an odour, flavour, colour, texture and dimensions that are particularly palatable to the animal to whom the medicament is aimed.

Therefore, if the medicament was aimed at a domestic pet, then it is preferred that the edible body comprises domestic pet food, such as cat food or dog food. However, if the medicament is intended for human use, an edible body having a palatable taste and texture to humans (such as a fruit flavoured jelly or the like) would be chosen.

Advantageously, by enclosing the medicament in an edible body, the natural instinct of a person to chew the edible body and the medicament contained therein before swallowing will be diminished. It is therefore preferred that the edible body is shaped and dimensioned to be consumed substantially whole.

The receptacle may be in the form of a tub or the like. The receptacle may be manufactured from aluminium, flexible plastics (such as a polyethylene bag), a rigid or semi rigid plastics, or cardboard which has preferably been lined with a plastics layer. However, it is particularly preferred that receptacle has flexible walls and/or base portion to aid in removal of the edible body from the receptacle.

Preferably, the system further includes a second removable cover member. The second removable cover member may be arranged to define a medicament storage area.

The medicament storage area may be arranged to contain a medicament prior to the medicament being inserted in the edible body. It is envisaged that the medicament is not inserted into the edible body until shortly before the medicament is to be administered as degradation of the medicament may occur.

Advantageously, according to a first embodiment, the second cover member may be arranged to cover a portion of the first cover member such that the medicament storage area is defined by the first cover member and the second cover member. In this embodiment, it is particularly preferred that the protrusion is hollow.

Alternatively, the second cover member may be removably attached to a base portion of the receptacle. In this embodiment, the area defined by the receptacle and the second cover member defines the medicament storage area.

It is particularly preferred that the medicament storage area further includes a medicament protection device to substantially protect the medicament during transportation or storage of the system. The medicament protection device may include padding or wadding, such as cotton wool.

The first cover member and the second cover member may be attached to the receptacle by standard means known in the field. For example, the first cover member and/or the second cover member may be attached to the receptacle by an adhesive (which has been approved for food use) or by push-on-pull-off type means.

The first cover member, the second cover member and/or the third cover member are preferably manufactured from a flexible, non-porous material.

The protrusion is preferably of a rigid or semi-rigid material. Advantageously, the protrusion is of sufficient rigidity to create and/or maintain an indentation in the edible body.

It is particularly preferred that each cover member includes a release tab which is substantially not attached to the receptacle; the release tab permitting easy release of each cover member from the receptacle.

It is envisaged that the first cover member, the second cover member and/or the third cover member may have indicia thereon to assist the user in identification of the contents. The indicia may include portions of different colour, or may include a typographical indicia such as a numbers or letters. Preferably, instructions for use of the system are printed on an external portion of the system, for example on the first cover member, the second cover member, the third cover member and/or the receptacle.

Preferably, the receptacle has internal walls that are coated with a release agent prior to the edible body being inserted into the receptacle. A preferred release agent includes a silicon release agent.

The edible body is shaped and dimensioned to be consumed substantially whole.

According to a further aspect of the present invention, there is provided a system for aiding delivery of a medicament, which system includes:
a receptacle which includes an edible substance;
a first removable cover arranged to cover an open portion of the receptacle, the first removable cover member having a protrusion thereon arranged to project away from the removable cover member into the edible body when the system is in use; and
a second removable cover arranged to define a medicament storage area.

The receptacle, the first removable cover member and/or the second removable cover member, may be substantially as described hereinbefore, with reference to the first aspect of the present invention. It is also preferred that the medicament is substantially as described hereinbefore.

Advantageously, the receptacle may contain an edible body, substantially as described hereinbefore with reference to the first aspect of the present invention.

The present invention will now be described by way of example only, with reference to the accompanying drawings, wherein:

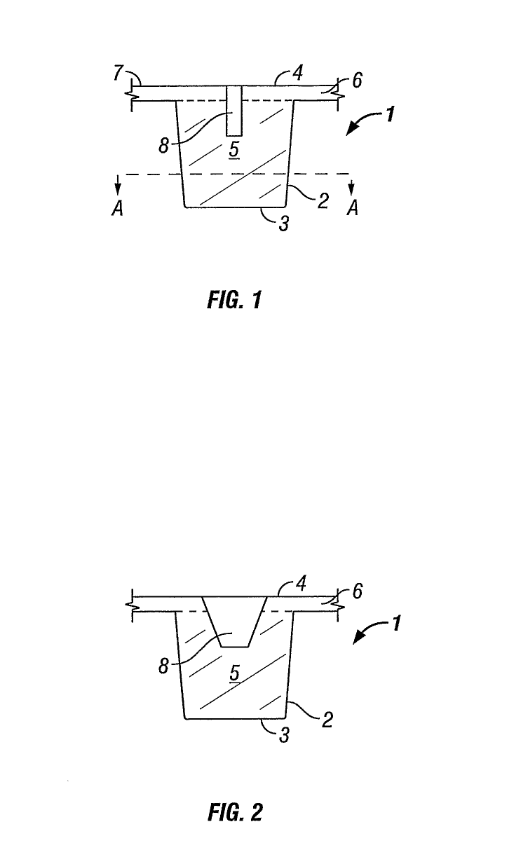

FIG. 1 represents a cross section of a medicament delivery system according to the present invention;

FIG. 2 represents a cross section of the medicament delivery system shown in FIG. 1 along the line A-A;

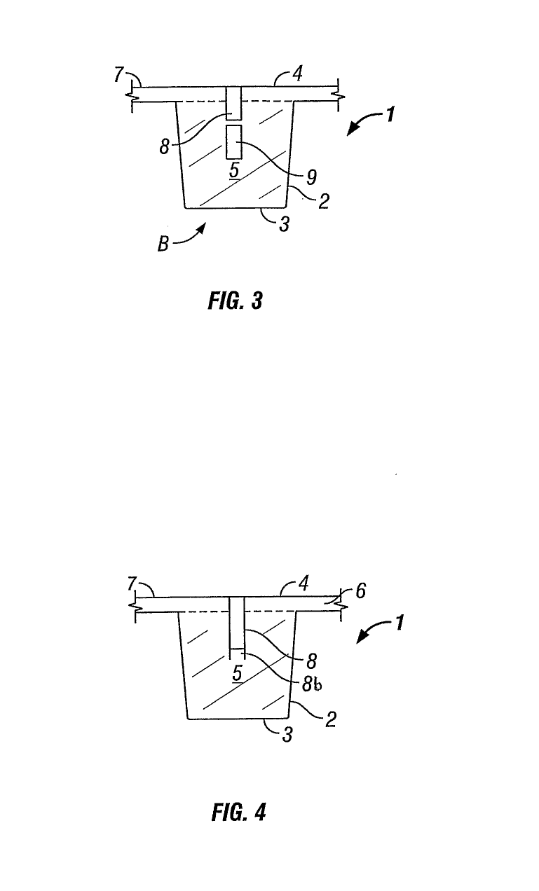

FIG. 3 represents a cross section of the medicament delivery system of FIG. 1 in use;

FIG. 4 represents a cross section of a second embodiment of a medicament delivery system according to the present invention;

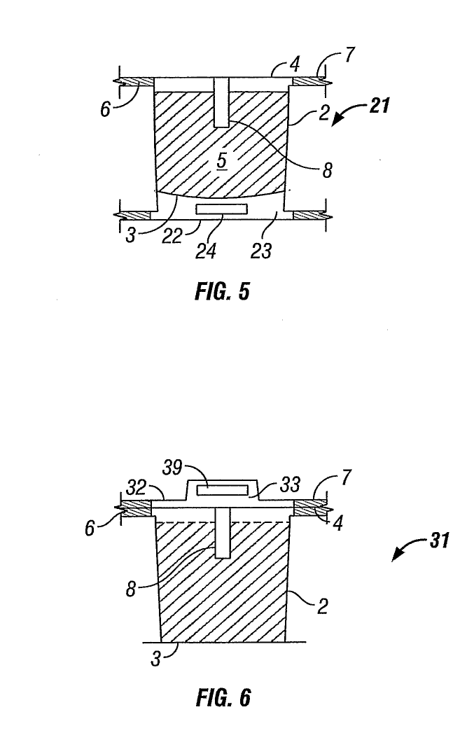

FIG. 5 represents a cross section of a third embodiment of a medicament delivery system according to the present invention; and

FIG. 6 represents a cross section of a medicament delivery system according to a second aspect of the present invention.

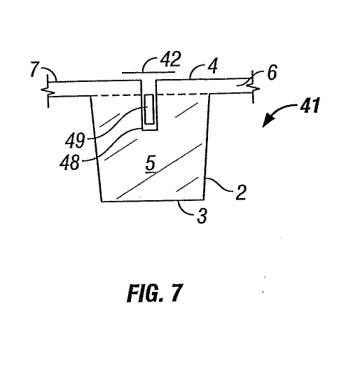

FIG. 7 represents a cross section of a further medicament delivery system according to a second aspect of the present invention.

Referring to FIGS. 1, 2 and 3, there is provided a medicament delivery system for administration of a medicament in tablet form to a domestic animal, generally indicated by the numeral 1. The medicament delivery system includes a plastics receptacle 2 in the form of a tub having a flexible base portion 3. The receptacle 2 has a first removable cover member 4 manufactured from aluminium foil. The first removable cover member 4 is attached to the receptacle 2 by food quality adhesive 6. The first removable cover member has a protrusion which extends into food 5. Lift tab portion 7 of cover member 4 is not attached, to the receptacle 2. The receptacle 2 contains dog food 5.

In use, the removable cover member 4 is peeled away from receptacle 2 so as to access the dog food 5; the protrusion is removed with the cover member 4 thereby accessing the food. A medicament 9 is inserted into dog food 5. The removable cover member 4 can then be placed back in position such that the protrusion 8 forces the medicament 9 further into the food 5; the cover member and also the protrusion are subsequently removed from the receptacle. The walls and/or base of the receptacle 5 are deformable, therefore, the user can squeeze the walls of the receptacle to envelop the medicament with the edible body; enveloping the medicament assists in preventing the medicament falling from the edible body when the receptacle is inverted. The receptacle 5 is then inverted onto a suitable feeding dish (not shown) for removal of food 5 from the receptacle; the food 5 substantially maintains the shape and dimensions of the inside of receptacle 2. The food 5(including a medicament) is positioned on feeding dish (not shown), for consumption by the domestic animal. Flexible base portion 3 assists in removal of the dog food 5 from the receptacle 2, as the user can apply pressure to the flexible portion 3 in the direction of arrow B when the receptacle 2 is in an inverted orientation.

Referring to FIG. 4, where like numerals have been used to identify like parts shown in FIGS. 1, 2 and 3, there is shown a medicament delivery device 1, however, the protrusion 8 further includes a location means 8b which is arranged such that, in use, the location means 8b assists in positioning and forcing the medicament in the food 5.

Referring to FIG. 5, where like numerals have been used to represent like parts in FIGS. 1, 2 and 3, there is provided a medicament delivery system 21. System 21 further includes a second removable cover member 22 which is arranged over the base portion 3 of the receptacle 21 such that the area between base portion 3 and second cover member 22 defines the medicament storage area 23. The medicament storage area is arranged to contain medicament 24.

Referring to FIG. 6, where like numerals have been used to represent like parts shown in FIGS. 1, 2 and 3, there is provided a medicament delivery system 31. System 31 is substantially the same as the system shown in FIG. 5, however, the second cover member 32 covers the first cover member 4 such that the area between the second cover member 32 and the first cover member 4 defines the medicament storage area 33 containing medicament 39.

Referring to FIG. 7, where like numerals have been used to represent like parts shown in FIGS. 1, 2 and 3, there is provided a medicament delivery system 41. System 41 is substantially the same as the system shown in FIG. 6, however, the second cover member 42 covers a hollow protrusion 48, thereby permitting the medicament 49 to be stored in the hollow protrusion 48.

What is claimed:

1. A system adapted to aid the delivery of a medicament, which system includes:
a receptacle which includes an edible body into which the medicament is to be placed when the system is in use; and
a first removable cover member arranged to substantially seal the edible body in the receptacle, wherein the first removable cover member has a protrusion thereon arranged to project away from the removable cover member into the edible body and push the medicament into the edible body when the system is in use by having placed the medicament in the edible body.

2. A system according to claim 1, wherein the protrusion has a cross-section which is semi-circular, triangular or trapezium shaped, or is hemispherical.

3. A system according to claim 1, wherein the protrusion is substantially hollow.

4. A system according to claim 1, wherein the edible body has a colour mark thereon so as to visibly indicate where the medicament is to be inserted or positioned in the edible body.

5. A system according to claim 1, wherein the protrusion includes a locating means.

6. A system according to claim 1, wherein the edible body is a foodstuff having a solid or semi-solid consistency.

7. A system according to claim 1, wherein the medicament is an edible medicament.

8. A system according to claim 1, wherein the receptacle is in a form of a tub.

9. A system according to claim 1, wherein the receptacle is manufactured from aluminium, a flexible plastics a rigid or semi rigid plastics, or cardboard.

10. A system according to claim 1, wherein the receptacle has flexible walls and/or base portion to aid in removal of the edible body containing the medicament from the receptacle, when the medicament is delivered to an individual.

11. A system according to claim 1, wherein the system further includes a second removable cover member.

12. A system according to claim 11, wherein the second removable cover member is arranged to define a medicament storage area.

13. A system according to claim 12, wherein a medicament is contained in the medicament storage area.

14. A system according to claim 12, wherein the medicament storage area further includes a medicament protection device.

15. A system according to claim 11, wherein the second removable cover member is attached to a bottom portion of the receptacle.

16. A system according to claim 11, wherein the second removable cover member is attached to the first removable cover member.

17. A system according to claim 11, wherein each cover member is attached to the receptacle or each other by an adhesive or by push-on-pull-off type means.

18. A system according to claim 11, wherein each cover member is manufactured from a flexible, non-porous material.

19. A system according to claim 1, wherein the protrusion is manufactured from a rigid or semi-rigid material.

20. A system according to claim 11, wherein each cover member includes a release tab which is substantially not attached to the receptacle.

21. A system according to claim 11, wherein each cover member has indicia thereon to assist a user in identification of contents.

22. A system according to claim 1, wherein the receptacle has internal walls that are coated with a release agent prior to the edible body being inserted into the receptacle.

23. A system according to claim 1, wherein the edible body is shaped and dimensioned to be consumed substantially whole.

24. A system according to claim 7, wherein the medicament comprises a form of a tablet, a pellet, a capsule, or a granule.

25. A system according to claim 9, wherein the flexible plastics comprise a polyethylene bag.

26. A system according to claim 9, wherein the cardboard has been lined with a plastics layer.
